(19) United States
(12) Patent Application Publication
(10) Pub. No.: US 2025/0015430 A1
(43) Pub. Date: Jan. 9, 2025

(54) DEGASSING CHANNEL ARRANGEMENT, HOUSING ARRANGEMENT, BATTERY, AND METHOD FOR PRODUCING A DEGASSING CHANNEL ARRANGEMENT FOR A BATTERY OF A MOTOR VEHICLE

(71) Applicant: AUDI AG, Ingolstadt (DE)

(72) Inventors: Imke DITTMANN, Ingolstadt (DE); Thorsten KEIM, Heilbronn (DE); Thomas MILDE, Wustenrot (DE); Martin SCHÜSSLER, Kosching (DE)

(73) Assignee: AUDI AG, Ingolstadt (DE)

(21) Appl. No.: 18/670,961

(22) Filed: May 22, 2024

(30) Foreign Application Priority Data
Jul. 6, 2023 (DE) 102023117814.8

(51) Int. Cl. H01M 50/358; H01M 50/204; H01M 50/249; H01M 50/342

(52) U.S. Cl. CPC H01M 50/358; H01M 50/204; H01M 50/249; H01M 50/3425; H01M 2220/20

(57) ABSTRACT

A degassing channel arrangement for a battery of a motor vehicle for discharging gases from a battery cell of the battery, has and having at least one degassing channel. The degassing channel arrangement includes a carrier for a battery housing of the battery, which carrier is designed as a hollow profile and extends in a first direction. A channel wall of the degassing channel represents a first part of a carrier wall of the carrier, which surrounds a first carrier interior of the carrier, and a channel interior of the degassing channel represents at least a part of a first carrier interior, in which at least one first sealing unit is arranged, which separates in a sealing manner a first subarea of the first carrier interior from a second subarea of the first carrier interior comprising the channel interior of the degassing channel.

### FIELD

The invention relates to a degassing channel arrangement for a battery of a motor vehicle for discharging gases from a battery cell of the battery, wherein the degassing channel arrangement has at least one degassing channel which comprises a channel wall which encloses a channel interior of the degassing channel, which has at least one inlet opening via which a gas emerging from the battery cell of the battery is introducible into the channel interior of the degassing channel, and which has at least one releasable outlet opening via which a gas introduced into the channel interior is dischargeable from the degassing channel in the released state of the at least one outlet opening. The invention furthermore also relates to housing arrangement for a battery, a battery, and a method for producing a degassing channel arrangement.

### BACKGROUND

Various concepts for discharging gases from battery cells of a battery, for example in case of thermal runaway of such a battery cell, are known from the prior art.

DE 10 2005 021 421 B3 describes an accumulator having a battery housing divided into cell vessels and having a lower cover that tightly seals the cell vessels and has openings for the cell vessels that open into a degassing channel system placed on the lower cover. Annular protrusions are formed on the lower cover adjacent to each opening and the degassing channel system has fastening means to clamp the degassing channel system onto the lower cover in such a way that the protrusions seal the openings to the degassing channel system by surface pressure.

DE 10 2013 201 365 A1 describes a battery module which comprises battery cells, each of which comprises a degassing element in order to release gases generated within the respective battery cell from the battery cell when a predetermined gas pressure is present. The battery module furthermore comprises an airtight degassing channel which is arranged above the degassing elements of the battery cells, wherein gases discharged through the degassing elements of the battery cells emerge into the degassing channel. In this case, a closure flap is arranged within the degassing channel between the degassing elements, which divides the degassing channel in a first state into a first and a second airtight chamber, each of which is assignable to the battery cells.

In principle, it would still be desirable to provide a degassing channel arrangement that is as simple and, above all, as space-saving as possible, without reducing the efficiency of the gas discharge.

### SUMMARY

The object of the present invention is therefore to provide a degassing channel arrangement, a housing arrangement, a battery, and a method which enable the most efficient possible gas discharge of a gas emerging from a battery cell of the battery in the most space-saving manner possible.

This object is achieved by a degassing channel arrangement, a housing arrangement, a battery, and a method having the features according to the respective independent claims. Advantageous embodiments of the invention are the subject matter of the dependent claims, the description, and the figures.

A degassing channel arrangement according to the invention for a battery of a motor vehicle for discharging gases from a battery cell of the battery has at least one degassing channel which comprises a channel wall which encloses a channel interior of the degassing channel, which has at least one inlet opening via which a gas emerging from the battery cell of the battery is introducible into the channel interior of the degassing channel, and which has at least one releasable outlet opening via which a gas introduced into the channel interior is dischargeable from the degassing channel in the released state of the at least one outlet opening. The degassing channel arrangement comprises a carrier for a battery housing of the battery, which carrier is designed as a hollow profile and extends in a first direction, wherein the channel wall of the degassing channel represents a first part of a carrier wall of the carrier, which surrounds a first carrier interior of the carrier, wherein the channel interior of the degassing channel represents at least a part of the first carrier interior, and wherein at least one first sealing unit is arranged in the first carrier interior, which seals and separates a first subarea of the first carrier interior from a second subarea of the first carrier interior comprising the channel interior of the degassing channel.

The invention is based on the finding that battery housings of batteries, in particular of high-voltage batteries, often have carriers designed as hollow profiles, which can, for example, form a frame of such a battery housing. The interior of these hollow profile carriers typically remains empty and thus represents unused installation space. The invention makes use of this knowledge in order to now simultaneously use such a carrier designed as a hollow profile as a degassing channel. A gas emerging from a battery cell and to be discharged can now advantageously be introduced into the carrier interior, guided to at least one releasable outlet opening, and discharged therefrom. The carrier, which is designed as a hollow profile, does not necessarily have to provide the complete gas discharge path from the battery cell to the outlet opening, but at least a part thereof. By integrating at least one degassing channel into such a carrier, installation space can advantageously be saved, since previously unused installation space can advantageously be used for this purpose. In addition, the invention is also based on the finding that it is advantageous for efficient gas discharge to provide one or more outlet openings which, in total, provide a sufficiently large passage area for the emerging gas in order to avoid gas backflow or the like. This can be achieved, for example, using only one or a few large outlet openings or smaller but significantly more outlet openings. Providing one or more larger outlet openings has the advantage that this in turn can save costs and also reduces the assembly effort, in particular because these are not just simple holes, but such an outlet opening is designed having a release mechanism by which the outlet opening is closed in the normal case, i.e., when no gas is to be discharged, and which releases the outlet opening, i.e., opens it, in case of degassing. For large outlet openings, however, the arrangement options are in turn severely limited due to installation space. In contrast, however, a carrier as part of a battery housing of the battery typically offers a sufficiently large lateral surface, at least partially provided by the carrier wall, into which large outlet openings having corresponding release mechanisms, for example a pressure relief valve, can also be integrated. This permits a more efficient design of the degassing channel arrangement.

A further advantage also results in combination with a preferred embodiment of the invention, according to which the gas discharge from battery cells of a battery takes place downwards with respect to a proper installation position in a motor vehicle, so that the gas emerging from the battery cell is first introduced into an intermediate space between a housing base of the battery housing and an underrun protection. From this intermediate space, the gas can now advantageously be guided into said carrier and discharged via the outlet opening integrated therein. This has the advantage that the releasable outlet opening does not have to be integrated into an area below the housing base, for example into a side wall that laterally delimits said intermediate space between the housing base and the underrun protection. This in turn makes it possible to reduce the distance between the underrun protection and the housing base, thus saving further installation space in the vehicle vertical direction.

Another great advantage of the invention is moreover that at least one first sealing unit is arranged in the carrier interior. This advantageously makes it possible to seal at least part of the carrier interior in a fluid-tight manner, so that the gas introduced into the degassing channel cannot escape from the carrier interior, except from the at least one outlet opening provided for this purpose. An uncontrolled gas emergence elsewhere can thus advantageously be avoided. In addition, this eliminates the need for complex sealing of the carrier on its front sides. This also makes it possible to seal only a subsection of the carrier interior. The remaining sections not used as degassing channels accordingly do not need to be sealed. This simplifies, for example, the installation of other components on the carrier, for example via screw connections, which then do not have to be embodied as sealed or fluid-tight.

In principle, it is conceivable to integrate such a sealing unit as a welded partition wall into the carrier interior and thus spatially separate the two subareas of the interior of the carrier in a sealed manner. However, due to the usually very limited accessibility to the carrier interior, this is very difficult.

Accordingly, it represents a further very advantageous embodiment of the invention if the first sealing unit comprises a cured sealing compound. Such a sealing compound can be introduced in a simple manner in the uncured and, for example, viscous state into the carrier inside, i.e., the carrier interior, for example via an inlet opening in the carrier wall, and can then accordingly form at least part of said sealing unit. Such a sealing compound can adapt particularly easily to the internal geometry of the carrier interior and thus, for example, compensate for manufacturing tolerances very easily. Such a sealing compound can also automatically close the above-mentioned sprue opening, through which the sealing compound can be decanted into the interior of the carrier, after curing. In this way, access to the carrier interior for introducing the sealing unit or at least a part thereof in the form of the sealing compound can become or be created in a simple manner, which can be automatically closed again by the sealing compound itself, in particular sealed in a fluid-tight manner.

In principle, it is conceivable that the degassing channel arrangement also comprises multiple degassing channels. However, it can also have at least one degassing channel as the single degassing channel. If it comprises multiple degassing channels, they can be fluidically separated from one another or fluidically coupled to one another. Further degassing channels can also extend outside the carrier. Optionally, multiple degassing channels can be integrated into the carrier at the same time.

The carrier is preferably made of a metallic material, for example steel. The carrier provides the degassing channel. The entire carrier does not necessarily have to function as a degassing channel. For example, only a section of the carrier in the first direction may function as such a degassing channel. It is also conceivable that the carrier is designed as a subdivided hollow profile having multiple hollow profile chambers. This means that the carrier has, for example, an interior surrounded by an outer wall of the carrier, which is further subdivided into individual partial interiors by at least one or more, in particular parallel, intermediate webs, which, for example, connect opposite sides of the outer wall of the carrier to one another. One of these partial interiors can accordingly provide the first carrier interior. The carrier can therefore, for example, have a second carrier interior which is arranged above or below the first carrier interior in a third direction which will be defined in more detail later and which is perpendicular to the first direction. The carrier can also optionally have more than just two carrier interiors. The individual carrier interiors can also be referred to as extruded profile chambers of the carrier. The carrier as a whole can therefore be designed as an extruded profile.

It has been found that the use of a single such carrier interior is sufficient to provide a degassing channel. Therefore, it is very advantageous, especially if the carrier has multiple such carrier interiors, to use only one such carrier interior for the degassing channel. It is then not necessary to ensure that the other interiors of the carrier are sealed accordingly.

The at least one outlet opening can, for example, comprise a degassing valve. This can be designed in such a way that it opens the outlet opening when the pressure prevailing inside the channel interior exceeds a certain pressure threshold value, in particular in comparison to an external pressure or ambient pressure outside the carrier, and closes the outlet opening when the pressure prevailing inside the channel is less than or equal to this pressure threshold value. Such a degassing valve can be designed to be reversibly resealable or only irreversibly releasable, for example by means of a bursting membrane.

In a further advantageous embodiment of the invention, the sealing unit comprises a casting mold, arranged in the first carrier interior on the carrier wall, having casting mold walls which, optionally together with one or more areas of the carrier wall, enclose at least one cavity of the casting mold filled with the sealing compound. Such a mold can advantageously be used to hold the sealing compound in position during filling and in its still viscous state and to prevent uncontrolled flowing away of the sealing compound. This casting mold itself does not have to terminate fluid-tight with the carrier wall in the carrier interior. For example, small gaps or free spaces can also remain. These can also be filled with the decanted sealing compound, for example, and the casting mold can thus be sealed fluid-tight in relation to the carrier wall. For this purpose, the sealing compound can be very viscous in the viscous state, so that it can also fill smaller intermediate spaces between the casting mold and the carrier wall without immediately spreading over the entire carrier interior and flowing away. A suitable sealing compound can be provided, for example, by butyl. Other sealing compounds are also conceivable. The casting mold therefore advantageously makes it possible to hold the sealing compound locally at the desired location until the sealing compound cures. The casting mold then remains in the carrier interior. To insert the mold into the carrier interior, it can simply be pushed through an opening on the front of the hollow profile of the carrier to the desired position.

In a further advantageous embodiment of the invention, at least one second sealing unit is arranged in the first carrier interior of the carrier, which separates in a sealing manner a third subarea of the first carrier interior from the second subarea of the first carrier interior comprising the channel interior of the degassing channel. Both end areas of the degassing channel can thus be sealed by a corresponding sealing unit within the first carrier interior. Accordingly, in the present case only the second subarea of the carrier interior is used as a degassing channel, while the other two subareas, namely the first and third subareas of the first carrier interior, are not used as a degassing channel and in particular accordingly also do not have to be designed to be fluid-tight and accordingly also are not, since this saves costs and effort.

The second sealing unit can otherwise be designed in exactly the same way as described for the first sealing unit. In other words, it is preferred that the second sealing unit also comprises a corresponding casting mold, as well as a cured sealing compound which fills a cavity provided by the casting mold.

According to a further advantageous embodiment of the invention, the degassing channel extends over the majority of the carrier in the first direction and the first and third subareas of the first carrier interior adjoin a respective first and second end of the carrier, which delimit the carrier on both sides with respect to the first direction, in particular wherein the degassing channel comprises multiple inlet openings arranged spaced apart in the first direction and/or multiple releasable outlet openings arranged spaced apart in the first direction. This means that a majority of the carrier, in particular the first carrier interior, can advantageously be used as a degassing channel without having to carry out complex sealing welding at the profile end of the carrier.

In principle, the number of inlet openings can differ from the number of releasable outlet openings. For example, there may be multiple inlet openings but only a single outlet opening, or vice versa. However, there can also be as many inlet openings as outlet openings. Preferably, all inlet openings open into the second subarea of the first carrier interior, which thus provides the degassing channel. Likewise, the releasable outlet openings all open into the same, second subarea of the first carrier interior.

In a further very advantageous embodiment of the invention, the degassing channel arrangement comprises an underrun protection for the motor vehicle. This can, for example, be designed in the form of a plate. Furthermore, it is preferred that the underrun protection is fastened to the carrier by means of at least one screw connection comprising at least one screw in such a way that the screw partially projects into the second subarea of the first carrier interior, wherein the screw connection comprises a sealing element, in particular an annular sealing disk, which is arranged between a screw head of the screw and the carrier, in particular adjacent to the underrun protection. On the one hand, the carrier can also be used advantageously to fasten the underrun protection. In order to provide sufficient stability of this fastening, it is very advantageous to provide multiple screws, via which the underrun protection is screwed on along the carrier. At the same time, it is very advantageous if the degassing channel extends over a majority of the carrier in the first direction, as described above. If a cumbersome repositioning and redesign of the positions of these screw connections is to be avoided, this has the consequence that one or more screws for fastening the underrun protection to the carrier open into the second subarea of the first carrier interior, which represents or provides the degassing channel. It is therefore very advantageous to also make these screw connections fluid-tight. This can be achieved, for example, by a sealing element which is arranged between the screw head and the corresponding contact element against which the screw comes into contact with its screw head in the screwed-in state. This contact element is provided in particular by the underrun protection, for example on the lower side of the underrun protection. In principle, it is also conceivable to screw such a screw from the first carrier interior downwards into the underrun protection. However, screwing a screw from below through the underrun protection into the carrier is much easier due to the space available. The sealing element does not necessarily have adjoin the screw head itself, at least not if other elements, such as a washer or the like, are arranged between the screw head and the sealing element. The sealing element then advantageously seals the through opening through which the screw is passed to create the screw connection in a fluid-tight manner. In other words, the sealing element then accordingly seals the second subarea of the first carrier interior in a fluid-tight manner in relation to the surroundings.

In the same way, one or more screw connections can be designed in which a part of a screw projects into the second subarea of the first carrier interior and which are used, for example, to fasten other components, such as a component other than an underrun protection. Such a screw does not necessarily have to protrude from below into the first carrier interior, but can also be screwed laterally into the carrier. In general, such a screw can be screwed in from outside the carrier, partially protruding into the second subarea of the first carrier interior.

According to a further advantageous embodiment of the invention, the screw is designed as a self-tapping and/or self-drilling screw. This can also apply not only to a screw for attaching the underrun protection but also to other screws. Such a self-tapping and/or self-drilling screw automatically cuts through the component into which the screw is screwed by means of its thread when it is screwed in. This means that there is no need to drill a hole in advance into which the screw is screwed. This in turn has the result that the through opening, into which the screw is screwed and which in this case extends through the underrun protection and the carrier wall, seals extremely tightly with the screw neck itself. In other words, this screw connection is already very tight without the sealing element described above and, without the sealing element, ensures that in case of gas passing through the degassing channel, no or, if at all, only a small proportion of this gas could emerge from the location of this screw connection. However, the optional additional sealing element has the advantage that an even better sealing effect can be achieved, which is particularly advantageous above all if numerous such screws are provided along the carrier for fastening the underrun protection to the carrier, all of which protrude into the second subarea of the first carrier interior.

Furthermore, the invention also relates to a housing arrangement having a battery housing which has a degassing channel arrangement according to the invention or one of its embodiments.

In particular, the carrier can be part of the battery housing and, for example, provide a housing wall, for example a side wall or part of a frame of the battery housing. Accordingly, it represents a further advantageous embodiment of the invention if the battery housing has a receiving area for receiving at least one battery module, wherein the battery housing has a frame surrounding the receiving area, which frame comprises multiple frame walls, wherein at least one of the frame walls represents the carrier, in particular wherein the frame comprises as the frame walls two longitudinal members opposite to one another with respect to the first direction and two cross members opposite to one another with respect to a second direction perpendicular to the first direction, of which preferably at least one represents the carrier of the degassing channel arrangement.

The frame of such a battery housing can, for example, comprise two longitudinal members and two cross members. When arranged as intended in a motor vehicle, the longitudinal members preferably extend in the vehicle longitudinal direction and the cross members preferably extend in the vehicle transverse direction. The frame can, for example, enclose a substantially cuboid-shaped receiving area. As explained in more detail later, a housing base of the battery housing can be fastened or arranged on the lower side of the frame. The above-mentioned carrier, which provides the degassing channel, preferably represents one of the cross members of the frame. Particularly preferably, it represents the rear cross member in relation to the intended installation position in a motor vehicle, i.e., the cross member of the frame which is arranged closer to the rear of the vehicle. This allows emerging gases to be discharged particularly easily towards the rear of the vehicle and thus into a particularly safe area. In principle, the use of a longitudinal member as a degassing channel would also be conceivable, but is less preferred.

Longitudinal and transverse members can moreover all be designed as hollow profiles, in particular as extruded profiles.

In a further advantageous embodiment of the invention, the battery housing has a housing base which is arranged below the receiving area with respect to a third direction perpendicular to the first and second directions, wherein the housing arrangement comprises the underrun protection which is arranged below the housing base with respect to the third direction, wherein between the housing base and the underrun protection there is a sealed intermediate space which is fluidically connected to the at least one inlet opening of the degassing channel.

This has the great advantage that this sealed intermediate space, as already mentioned above, can also be used for gas removal or gas discharge of the gas emerging from the battery cell. The intermediate space can extend in the first and second directions over the entire surface of the housing base or at least almost the entire surface of the housing base. This means that a very large space below the housing base and in particular between the housing base and the underrun protection can be used for gas discharge. This makes it possible, for example, to additionally also integrate filter elements into this intermediate space to filter out particles carried in the gas. In addition, this makes it possible to make this intermediate space very low in the third direction, since the large width and/or length of this intermediate space provides sufficient passage area for gas discharge. A gas emerging from the battery cell can therefore advantageously first be introduced into this sealed intermediate space and is then introduced into the second area of the first carrier interior via the fluidic connection to the degassing channel and then finally discharged via the at least one outlet opening. The intermediate space can be fluidically connected to the inlet opening of the degassing channel by the inlet opening opening into this intermediate space. The underrun protection can therefore be attached to the carrier in such a way that the hole in the carrier wall, which provides the inlet opening, opens into this intermediate space. Furthermore, it is also preferred that the underrun protection is arranged in a sealing manner on the battery housing, in particular on the frame of the battery housing and/or on the housing base. This means that the gas introduced into the intermediate space cannot escape from this intermediate space at any other point and is therefore guided in a targeted manner into the degassing channel provided by the carrier and discharged via the outlet opening.

Furthermore, the invention also relates to a battery having a housing arrangement according to the invention or one of its embodiments. The advantages mentioned for the housing arrangement according to the invention and its embodiments thus apply equally to the battery according to the invention.

In a further very advantageous embodiment of the invention, the battery comprises a battery module having at least one battery cell, wherein the battery cell has a releasable cell degassing opening, wherein the battery module is arranged in the receiving area such that the releasable cell degassing opening faces toward the housing base.

The releasable cell degassing opening can be designed, for example, as a pressure relief valve and/or as a bursting membrane. in case of thermal runaway of a battery cell, gases are produced in this cell, which result in excess pressure in the interior of the battery cell. If this excess pressure reaches a certain pressure threshold value, the releasable cell degassing opening is opened and the gas can escape from the battery cell. This releasable cell degassing opening is now advantageously facing toward the housing base of the battery housing. This advantageously allows gas to be discharged downwards and thus away from a passenger compartment of the motor vehicle. The heat development associated with thermal runaway of a battery cell therefore also has little or no effect on the interior of the motor vehicle. In order to ensure that the gas emerging from a battery cell can penetrate the housing base, the housing base can have corresponding predetermined breaking points, for example in the form of a weakened material or in the form of a particularly thin-walled design. In addition, the housing base can generally also be designed as a cooling base. In other words, the housing base can simultaneously represent a cooling device for cooling the at least one battery module. For this purpose, the housing base can also have cooling channels through which a cooling medium can flow. Said predetermined breaking points for the passage of a gas emerging from a battery cell are then preferably arranged in an area of the housing base in which no cooling channels or cooling channel sections extend.

In general, the battery can also have multiple battery modules. Each of these battery modules can, for example, have one or more battery cells. The battery cells can be formed as lithium-ion cells, for example. In addition, the battery cells can be provided to provide a battery module in the form of a cell stack having multiple cells arranged adjacent to one another in the stacking direction. Each battery cell can have a corresponding cell degassing opening. The battery can be, for example, a high-voltage battery.

Furthermore, the invention also relates to a motor vehicle having a degassing channel arrangement according to the invention or one of its embodiments and/or having a housing arrangement according to the invention or one of its embodiments and/or having a battery according to the invention or one of its embodiments.

The motor vehicle according to the invention is preferably designed as an automobile, in particular as a passenger car or truck, or as a passenger bus or motorcycle.

Furthermore, the invention also relates to a method for producing a degassing channel arrangement for a battery of a motor vehicle for discharging gases from a battery cell of the battery, wherein at least one degassing channel is provided which has a channel wall which encloses a channel interior of the degassing channel, which has at least one inlet opening and which has at least one releasable outlet opening. The degassing channel arrangement comprises a carrier for a battery housing, which carrier is designed as a hollow profile and extends in a first direction, wherein the channel wall of the degassing channel represents a first part of a carrier wall of the carrier, which surrounds a first carrier interior of the carrier, wherein the channel interior of the degassing channel represents at least a part of the first carrier interior, and wherein at least one first sealing unit is arranged in the first carrier interior, which separates in a sealing manner a first subarea of the first carrier interior from a second subarea of the first carrier interior comprising the channel interior of the degassing channel.

The advantages mentioned for the degassing channel arrangement according to the invention and its embodiments also apply similarly to the method according to the invention.

In a further advantageous embodiment of the invention, the first sealing unit comprises a curable sealing compound which is decanted into the carrier interior in a viscous state when the first sealing unit is arranged in the first carrier interior. This allows a particularly simple and efficient design of such a sealing unit for sealing the degassing channel extending in the carrier.

Furthermore, it is advantageous if the sealing unit, as has already been described in particular in connection with the advantageous embodiments of the degassing channel arrangement, comprises a casting mold having casting mold walls, which is arranged in the first carrier interior when the first sealing unit is arranged in the first carrier interior before the sealing compound is decanted, wherein the casting mold walls enclose at least one cavity of the casting mold, which is filled with the sealing compound when the sealing compound is decanted. Furthermore, it is advantageous if the casting mold and the carrier wall have an at least partially overlapping respective opening providing a sprue opening through which the viscous sealing compound is decanted into the cavity of the casting mold in the first carrier interior. The respective openings in the carrier wall and the casting mold are therefore preferably aligned with one another and together form the sprue opening.

This allows particularly simple, cost-effective, and efficient sealing of the degassing channel.

The invention also includes refinements of the method according to the invention, which have features as already described in the context of the refinements of the degassing channel arrangement and the housing arrangement according to the invention and the battery according to the invention. For this reason, the corresponding refinements of the method according to the invention are not described again here.

The invention also comprises the combinations of the features of the described embodiments. The invention therefore also comprises implementations which each have a combination of the features of several of the described embodiments, unless the embodiments have been described as mutually exclusive.

### BRIEF DESCRIPTION OF THE FIGURES

Exemplary embodiments of the invention are described hereinafter. In the figures:

FIG. 1 shows a schematic representation of a motor vehicle having a degassing channel arrangement according to an exemplary embodiment of the invention;

FIG. 2 shows a schematic cross-sectional representation of a battery, a battery housing, and a degassing channel arrangement according to one exemplary embodiment of the invention; and

FIG. 3 shows a schematic representation of a cross section through a carrier of the battery housing, which provides the degassing channel, according to an exemplary embodiment of the invention.

### DETAILED DESCRIPTION

The exemplary embodiments explained below are preferred embodiments of the invention. In the exemplary embodiments, the described components of the embodiments each represent individual features of the invention to be considered independently of one another, which each also develop the invention independently of one another. Therefore, the disclosure is also intended to comprise combinations of the features of the embodiments other than those represented. Furthermore, the described embodiments can also be supplemented by further ones of the above-described features of the invention.

In the figures, the same reference numerals respectively designate elements that have the same function.

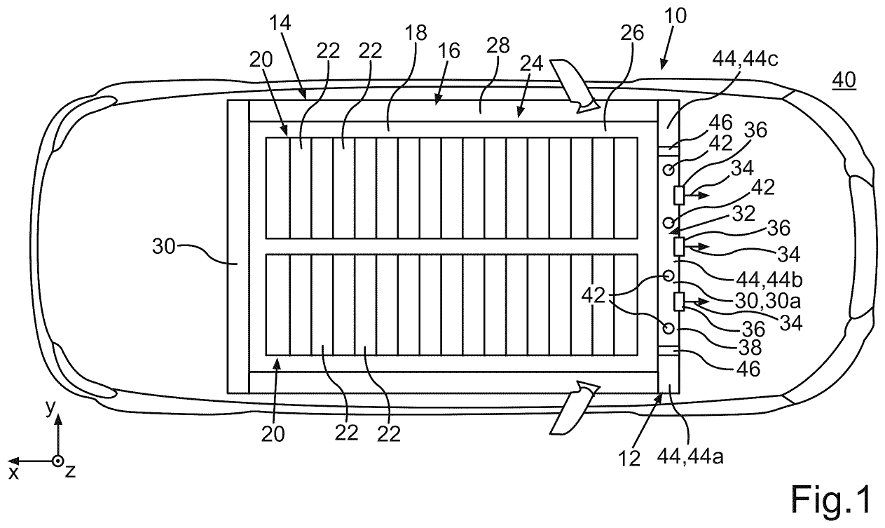

FIG. 1 shows a schematic representation of a motor vehicle 10 having a degassing channel arrangement 12 according to an exemplary embodiment of the invention. The motor vehicle 10 has a battery 14, for example a high-voltage battery 14, which comprises a battery housing 16 that provides a receiving area 18 in which at least one and in this case multiple battery modules 20 are arranged. The battery modules can each comprise one or more battery cells 22, of which only some are provided with a reference numeral for reasons of clarity. FIG. 1 shows in particular the motor vehicle 10 in a cross section perpendicular to the illustrated z-direction, which is substantially parallel to a vehicle vertical axis of the motor vehicle 10. The cross section therefore extends essentially parallel to the x-y plane of the coordinate system shown, in particular through the battery 14.

The battery housing 16 comprises a frame 24 which delimits the receiving area 18 in and opposite to the y-direction as well as in and opposite to the x-direction. The receiving area 18 is delimited opposite to the illustrated z-direction by a base 26 of the battery housing 16. This can be attached to the lower side of the frame 24. The frame 24 is in turn formed from multiple individual parts which provide the respective side walls of the frame 24. In particular, the frame 24 in the present example comprises two longitudinal members 28 and two cross members 30. The cross members extend essentially parallel to the vehicle transverse direction, which in the present example is aligned essentially parallel to the y-direction, and the longitudinal members 28 extend in the vehicle longitudinal direction, which is aligned essentially parallel to the x-direction shown. These supports 28, 30 are designed as hollow profiles, in particular having multiple inner chambers. This now advantageously makes it possible to use at least one of these supports 28, 30, preferably a cross member 30, such as the rear cross member 30a in this example, as a degassing channel 32, via which gas 34 emerging from one of the battery cells 22 can be discharged from the battery 14 and in particular from the motor vehicle 10. In particular, this gas 34 is represented in FIG. 1 by the arrows exiting from the outlet openings 36, which in turn are part of the degassing channel 32. In a released state of these outlet openings, these outlet openings 36 consequently establish a fluidic connection between the channel interior 38 and the surroundings 40 of the motor vehicle 10. A respective outlet opening 36 is thus designed as a releasable outlet opening 36 and comprises a degassing valve 76 for closing and in particular pressure-dependent releasing of the outlet opening 36. It is preferred that no further exhaust gas routing system is connected to the respective outlet openings 36, but that these released outlet openings 36 open directly into the surroundings 40. In addition, FIG. 1 shows, by way of example, multiple inlet openings 42 via which the gas emerging from a battery cell 22 can be introduced into the degassing channel 32.

It is not necessary for the entire cross member 30, 30a to be used as such a degassing channel 32. It is also possible for only a part of this cross member 30, 30a in the y-direction to provide the degassing channel 32, as is also shown in FIG. 1. Basically, in this example, the carrier 30, 30a can be divided into three areas, more precisely, a first carrier interior 44 can be divided into three subareas, namely a first subarea 44a of the carrier interior 44, a second subarea 44b of the carrier interior 44, and a third subarea 44c of the carrier interior 44. In the present example, the degassing channel 32 is limited to the second subarea 44b. In other words, the channel interior 38 of the degassing channel 32 is provided by the second subarea 44b of the first carrier interior 44. The first and third subareas 44a, 44c of the first carrier interior 44 do not comprise any part of the channel interior 38 and are also separated from the channel interior 38 in a fluid-tight manner. In other words, during gas discharge, the gas is not guided into the first or third subarea 44a, 44c. Accordingly, it is also very advantageous if the second subarea 44b of the carrier interior 44 is sealed off in relation to these other subareas 44a, 44c, which is implemented in the present example by two sealing units 46. The advantageous design of these sealing units 46, which are arranged in the first carrier interior 44, will be explained in more detail later.

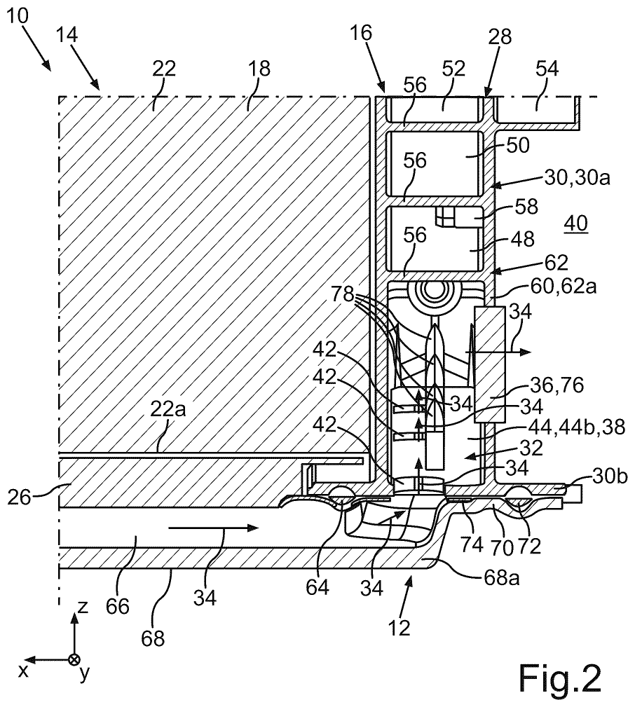

FIG. 2 shows a schematic cross-sectional view of a part of the motor vehicle 10 or of the battery 14 comprised thereby. The cross section shown extends perpendicular to the y-axis shown.

The illustration also shows in particular the cross member 30, 30a already described, or at least a part thereof. This is designed as a hollow profile and in this example comprises multiple inner chambers 44, 48, 50, 52, 54, which are spatially and fluidically separated from one another by respective separating webs 56 of the carrier 30, 30a. A first of these chambers, which in the present example represents the lowest chamber 44, represents the first carrier interior 44 already described. In addition to this first carrier interior 44, the carrier 30, 30a can also have further interior areas 48, 50, 52, 54, which are provided by the above-mentioned chambers 48, 50, 52, 54. However, these are not used for gas discharge. This has the advantage that other components can be fastened to the carrier 30, 30a in the region of these additional chambers 48, 50, 52, 54, for example by suitable fastening means 58, wherein the fastening interfaces then do not have to be designed to be fluid-tight and preferably are not, since no gas exchange is possible in any case between these further chambers 48, 50, 56, 54 and the second subarea 44b of the first chamber 44.

In particular, the cross section shown shows the first carrier interior 44 in the area of the second subarea 44b, which simultaneously also provides the chamber interior 38 of the degassing channel 32. The degassing channel 32 also has a channel wall 60, which is simultaneously provided by a part 62a of the carrier wall 62. The carrier wall 62 can be understood as the entirety of the carrier walls, including the separating webs 56, which surround or adjoin the described chambers 44, 48, 50, 52, 54.

The gas discharge of the battery 14 is now advantageously designed as follows: The battery cells 22 received in the receiving area 18 have a respective cell degassing opening, which is not shown here and which is directed downwards. In other words, this cell degassing opening is located on a lower side 22a of a respective battery cell 22. The gas emerging from a cell 22 is thus discharged downwards, i.e., opposite to the z-direction shown. The housing base 26 is located under a respective battery cell. This is fastened in particular to the frame 24 of the housing 16, for example by means of screws or other fastening means. In addition, the housing base 26 can also be sealed in relation to the frame 24, for example by means of a peripheral seal 64. The base 26 can be designed having a corresponding predetermined breaking point at least in the area of the respective cell degassing openings of the cells 22 or can generally be designed to be correspondingly thin so that the gas emerging downwards from a cell 22 can penetrate the base 26 and in this way arrive in an intermediate space 66 between the base 26 and an underrun protection 68. The intermediate space 66 is fluid-tight except for a fluidic connection to the channel interior 38 of the degassing channel 32.

The underrun protection 68 is also fastened to the carrier 30, 30a via fastening elements, for example screws 78. Between the carrier 30, 30a and the underrun protection 68, one or more peripheral seals 72, 74 can be arranged, due to which the intermediate space 66 is fluid-tight. In the present example, these seals 72, 74 extend between a sealing flange 30b of the carrier 30, 30a and a sealing flange 70 of the underrun protection 68. The fluidic connection to the degassing channel 32 is provided by the inlet openings 42 already mentioned and described in relation to FIG. 1. The gas emerging from a battery cell is again illustrated here by corresponding arrows 34 on its way to the outlet opening 36. Although only one outlet opening 36 is shown here, multiple releasable outlet openings 36, as described for FIG. 1, can also be provided here, for example six releasable outlet openings 36. The gas 34 emerging from a cell 22 thus accordingly penetrates the housing base 26, reaches the intermediate space 66, and is introduced via one or more inlet openings 42 into the degassing channel 32, in particular into the channel interior 38, which is provided by the second subarea 44b of the first carrier interior 44 of the carrier 30, 30a, namely the cross member 30a. The gas 34 can then accordingly flow through the first carrier interior 44 within the second subarea 44b to the at least one outlet opening 36 and then accordingly exit from the carrier 30, 30a into the surroundings 40.

In addition, further screws 78 are shown here, by means of which the underrun protection 68 is also fastened, in particular screwed, to the carrier 30. In particular, only the screw ends of the screws 78 which protrude into the channel interior 38 can be seen.

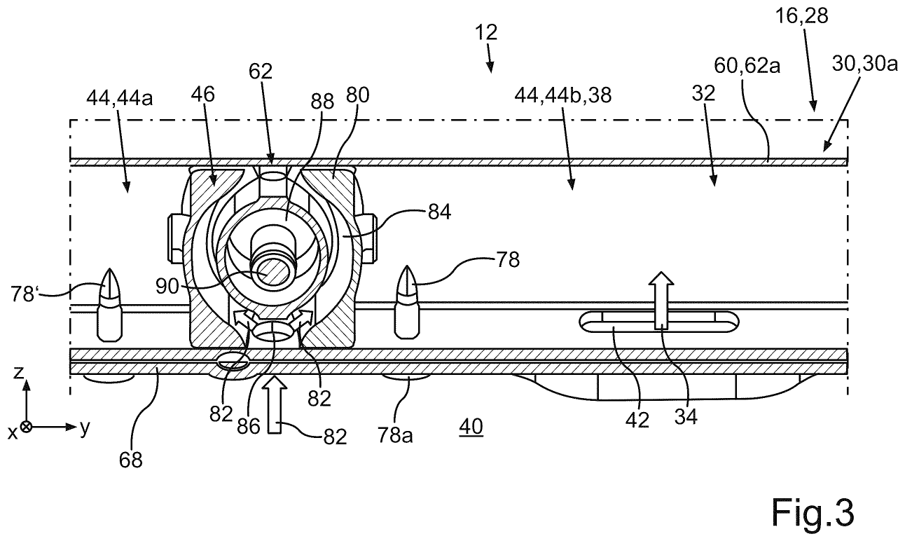

FIG. 3 shows a schematic cross-sectional view through the carrier 30, 30a from FIG. 2 perpendicular to the illustrated x-direction. The illustration shows in particular the carrier interior 44 in the area of the first subarea 44a and in the area of the second subarea 44b, which simultaneously represents the channel interior 38. In addition, an inlet opening 42 can also be seen here, through which the gas 34 can penetrate into the degassing channel 32, i.e., into the channel interior 38. The second subarea 44b is fluidically sealed from the first subarea 44a, as already mentioned in FIG. 1, by a corresponding sealing unit 46. This is shown here in detail and in cross section. In particular, FIG. 3 shows the sealing unit 46 in a not yet cast state. The sealing unit 46 comprises a casting mold 80, which provides a cavity 84 that can be filled by a casting compound or sealing compound 82. In addition, a corresponding sprue opening 86 is arranged in the carrier 30, 30a as well as in the corresponding underrun protection 68 arranged thereon, which fluidically connects the surroundings to the interior of the cavity 84 in the first carrier interior 44. Through this sprue opening 86, a sealing compound 82, which is again illustrated here as an example by arrows 82, can be decanted into the cavity 84. The sealing compound 82 is decanted in the viscous state and hardens within the cavity 84 and in this way seals the two subareas 44a, 44b from one another. In the viscous state, the sealing compound 82 can also penetrate into small gaps between the sprue 80 and the carrier wall 62 and thus additionally seal the casting mold 80 in relation to the carrier wall 62.

The casting mold 80 makes it possible to hold the viscous sealing compound 82 in the desired position or to initially bring it to the desired position and, if necessary, to leave out further free areas 88, i.e., to ensure that the sealing compound 82 cannot get into such free areas 88 to be kept free during filling. This makes it possible to provide further components 90, for example fastening means or the like, in such free areas 88, which are not to come into contact with the sealing compound 82. The other sealing unit 46, which, as shown in FIG. 1, is arranged between the second subarea 44b and the third subarea 44c, can be designed analogously to that described for the sealing unit 46 shown in FIG. 3.

In FIG. 3, screws 78, 78′ can also be seen, via which the underrun protection 68 is attached to the carrier 30, 30a. In particular, the screw 78 protrudes into the second subarea 44b. The connection interface between the screw 78 and the carrier 30, 30a is accordingly designed to be fluid-tight. On the one hand, this can be achieved by designing the screw 78 as a self-tapping or self-drilling screw. In addition, a seal, for example a sealing disk, can be arranged between the screw head 78a and the carrier 30, 30a, in particular the underrun protection 68, via which the screw head 78a is sealed in relation to the underrun protection 68. The underrun protection is also sealed in relation to the carrier 30, 30a by the seals 72, 74 already described in FIG. 2. This means that no gas 34 can escape into the surroundings 40 at this screw interface.

The additionally shown screw 78′ in the first subarea 44a does not necessarily have to be designed to be sealing. In particular, the described sealing element can be dispensed with for this screw 78′.

In particular, further fastening means for fastening various other components to the carrier 30, 30a, which also at least partially protrude into the second subarea 44b, can also be designed to be correspondingly sealing. This advantageously makes it possible to design the degassing channel 32 in a fluid-tight manner. The gas 34 therefore cannot reach any other areas of the battery or the motor vehicle 10.

As can be seen in particular in FIG. 2, the degassing valve 76 has a height in the z-direction, which can in particular be in the range between three and five centimeters, and is, for example, four centimeters. This makes the degassing valve 76 relatively large. In order to save installation height in the z-direction in particular, it is also desirable to keep the height of the intermediate space 66 as low as possible. By positioning the degassing valve 76 in the carrier 30, 30a, it is now advantageously possible to make the height of the intermediate space 66 significantly smaller than would be possible if this valve 76 had to be integrated in one area, for example the side wall 68a of the underrun protection 68, as illustrated in FIG. 2. The higher position of the valve 76 also means a more protected position for the valve 76. This makes it even more difficult for dirt or contaminants to penetrate. This valve 76 is also no longer exposed so much to environmental influences, splashed water, etc. This can also be designed to be less robust and thus in turn more cost-effective.

Overall, the examples show how the invention can provide a degassing concept in case of a thermal cell event via the high-voltage battery frame. The relocation of the degassing valves from the underrun protection into the cross member of the high-voltage battery frame designed as an assembly part having sealed cover caps, which were also referred to as a casting mold, advantageously makes it possible to save installation space and, due to the higher positioning, to expose the valves, i.e., the releasable outlet openings, to less impact from environmental influences such as dust, water, and so on. The sealing units described also make it very easy to seal the extruded profile chambers through which the gas is guided in the frame assembly without the need for a sealing weld at the profile end. In addition, an increased cooling influence on the degassing flow is provided by rerouting the degassing path from the underrun protection into the cross member. The degassing path from the gas distributor in the underrun protection, i.e., from the intermediate space between the underrun protection and the housing base, takes place in the z-direction via openings in the lower profile wall of the cross member. The gas is distributed via this lower profile chamber of the cross member, which is provided by the first carrier interior, and flows to the outside via the installed degassing valves, i.e., the releasable outlet openings, for example in and/or against the x-direction. In order to avoid unwanted emergence of gas at the profile end of the cross member, the profile chamber is designed to be sufficiently sealed. For this purpose, so-called cover caps, also referred to as casting molds, can be inserted into the profile during the joining of the assembly of the frame assembled part. The cover caps are first positioned accordingly in their position with respect to the y-direction above the injection hole, which is also called the sprue opening. The sealing of the cover caps is carried out in a later process by injection through the injection hole by means of a sealant compound, which is also referred to as a sealing compound. The sealing compound flows around the cover cap within the geometry and forms the seal to the inner wall of the lower profile chamber of the cross member.

1. A degassing channel arrangement for a battery of a motor vehicle for discharging gases from a battery cell of the battery, comprising:
at least one degassing channel,
wherein the degassing channel has a channel wall which encloses a channel interior of the degassing channel,
wherein the degassing channel has at least one inlet opening via which a gas emerging from the battery cell of the battery can be introduced into the channel interior of the degassing channel, and
wherein the degassing channel has at least one releasable outlet opening via which a gas introduced into the channel interior can be discharged from the degassing channel in the released state of the at least one outlet opening,
wherein the degassing channel arrangement comprises a carrier designed as a hollow profile and extending in a first direction for a battery housing of the battery,
wherein the channel wall of the degassing channel represents a first part of a carrier wall of the carrier which surrounds a first carrier interior of the carrier,
wherein the channel interior of the degassing channel represents at least a part of the first carrier interior, and
wherein at least one first sealing unit is arranged in the first carrier interior, which separates, in a sealing manner, a first subarea of the first carrier interior from a second subarea of the first carrier interior comprising the channel interior of the degassing channel.

2. The degassing channel arrangement according to claim 1, wherein the first sealing unit comprises a cured sealing compound.

3. The degassing channel arrangement according to claim 1, wherein the sealing unit comprises a casting mold arranged in the first carrier interior on the carrier wall with casting mold walls which enclose at least one cavity of the casting mold filled with the sealing compound.

4. The degassing channel arrangement according to claim 1, wherein at least one second sealing unit is arranged in the first carrier interior of the carrier, which separates, in a sealing manner, a third subarea of the first carrier interior from the second subarea of the first carrier interior comprising the channel interior of the degassing channel.

5. The degassing channel arrangement according to claim 1, wherein the degassing channel arrangement comprises an underrun protection for the motor vehicle, which is fastened to the carrier by means of a screw connection comprising at least one screw in such a way that the screw partially projects into the second subarea of the first carrier interior, wherein the screw connection comprises a sealing element, in particular an annular sealing disk, which is arranged between a screw head of the screw and the carrier, in particular adjacent to the underrun protection.

6. A housing arrangement having a battery housing, comprising:
a degassing channel arrangement according to claim 1,
a receiving area for receiving at least one battery module, wherein the battery housing has a frame surrounding the receiving area and comprising multiple frame walls, wherein at least one of the frame walls represents the carrier, in particular wherein the frame comprises, as the frame walls, two longitudinal members opposite to one another with respect to the first direction and two cross members opposite to one another with respect to a second direction perpendicular to the first direction, of which in particular at least one represents the carrier of the degassing channel arrangement.

7. The housing arrangement according to claim 6, wherein the battery housing has a housing base which is arranged below the receiving area with respect to a third direction perpendicular to the first and second directions, wherein the housing arrangement comprises the underrun protection which is arranged below the housing base with respect to the third direction, wherein, between the housing base and the underrun protection, there is a sealed intermediate space which is fluidically connected to the at least one inlet opening of the degassing channel.

8. A battery comprising:
a housing arrangement according to claim 6;
a battery module having at least one battery cell, wherein the battery cell has a releasable cell degassing opening, wherein the battery module is arranged in the receiving area such that the releasable cell degassing opening faces toward the housing base.

9. A method for producing a degassing channel arrangement for a battery of a motor vehicle for discharging gases from a battery cell of the battery, wherein at least one degassing channel is provided,
which has a channel wall which encloses a channel interior of the degassing channel,
which has at least one inlet opening, and
has at least one at least releasable outlet opening;
wherein the degassing channel arrangement comprises a carrier designed as a hollow profile and extending in a first direction for a battery housing,
wherein the channel wall of the degassing channel represents a first part of a carrier wall which surrounds a first carrier interior of the carrier,
wherein the channel interior of the degassing channel represents at least a part of the first carrier interior, and
wherein at least one first sealing unit is arranged in the first carrier interior, which separates, in a sealing manner, a first subarea of the first carrier interior from a second subarea of the first carrier interior comprising the channel interior of the degassing channel.

10. The method according to claim 9, wherein the first sealing unit comprises a curable sealing compound which is decanted into the carrier interior in a viscous state when the first sealing unit is arranged in the first carrier interior.

11. The degassing channel arrangement according to claim 2, wherein the sealing unit comprises a casting mold arranged in the first carrier interior on the carrier wall with casting mold walls which enclose at least one cavity of the casting mold filled with the sealing compound.

12. The degassing channel arrangement according to claim 2, wherein at least one second sealing unit is arranged in the first carrier interior of the carrier, which separates, in a sealing manner, a third subarea of the first carrier interior from the second subarea of the first carrier interior comprising the channel interior of the degassing channel.

13. The degassing channel arrangement according to claim 3, wherein at least one second sealing unit is arranged in the first carrier interior of the carrier, which separates, in a sealing manner, a third subarea of the first carrier interior from the second subarea of the first carrier interior comprising the channel interior of the degassing channel.

14. The degassing channel arrangement according to claim 2, wherein the degassing channel arrangement comprises an underrun protection for the motor vehicle, which is fastened to the carrier by means of a screw connection comprising at least one screw in such a way that the screw partially projects into the second subarea of the first carrier interior, wherein the screw connection comprises a sealing element, in particular an annular sealing disk, which is arranged between a screw head of the screw and the carrier, in particular adjacent to the underrun protection.

15. The degassing channel arrangement according to claim 3, wherein the degassing channel arrangement comprises an underrun protection for the motor vehicle, which is fastened to the carrier by means of a screw connection comprising at least one screw in such a way that the screw partially projects into the second subarea of the first carrier interior, wherein the screw connection comprises a sealing element, in particular an annular sealing disk, which is arranged between a screw head of the screw and the carrier, in particular adjacent to the underrun protection.

16. The degassing channel arrangement according to claim 4, wherein the degassing channel arrangement comprises an underrun protection for the motor vehicle, which is fastened to the carrier by means of a screw connection comprising at least one screw in such a way that the screw partially projects into the second subarea of the first carrier interior, wherein the screw connection comprises a scaling element, in particular an annular scaling disk, which is arranged between a screw head of the screw and the carrier, in particular adjacent to the underrun protection.
